(19) United States
(12) Patent Application Publication
(10) Pub. No.: US 2026/0042414 A1
(43) Pub. Date: Feb. 12, 2026

(54) EXTRUDED AIRBAG RAMP

(71) Applicant: Vintech Industries, Inc., Imlay City, MI (US)

(72) Inventors: James Schoonover, Shelby Township, MI (US); Robert Rutoski, Imlay City, MI (US)

(73) Assignee: Vintech Industries, Inc., Imlay City, MI (US)

(21) Appl. No.: 19/363,157

(22) Filed: Oct. 20, 2025

Related U.S. Application Data
(63) Continuation-in-part of application No. 19/032,287, filed on Jan. 20, 2025.
Application No. 19/032,287 is a continuation of application No. 18/352,011, filed on Jul. 13, 2023, now Pat. No. 12,221,054.
Application No. 18/352,011 is a continuation of application No. 17/559,628, filed on Dec. 22, 2021, now Pat. No. 11,731,579.
Application No. 17/559,628 is a continuation of application No. 16/696,332, filed on Nov. 26, 2019, now Pat. No. 11,235,730.
(60) Provisional application No. 62/771,355, filed on Nov. 26, 2018.

(51) Int. Cl. B60R 21/232; B60R 21/16; B60R 21/213

(52) U.S. Cl. CPC B60R 21/232; B60R 21/213; B60R 2021/161

(57) ABSTRACT

An extruded side curtain airbag ramp including a tear-resistant material forming at least one attachment feature and method for manufacturing said extruded side curtain airbag ramp. The airbag ramp, according to the present invention incorporates a plurality of extruded materials and provides an easier manufactured product and attachment.

### CROSS REFERENCE TO RELATED APPLICATIONS

This application is a continuation-in-part of U.S. patent application Ser. No. 19/032,287, filed Jan. 20, 2025, which is a continuation of U.S. patent application Ser. No. 18/352,011, filed Jul. 13, 2023, now U.S. Pat. No. 12,221,054, which is a continuation of U.S. patent application Ser. No. 17/559,628, filed Dec. 22, 2021, now U.S. Pat. No. 11,731,579, which is a continuation of U.S. patent application Ser. No. 16/696,332, filed Nov. 26, 2019, now U.S. Pat. No. 11,235,730, which claims the benefit of U.S. Provisional Application No. 62/771,355 filed Nov. 26, 2018. The disclosures of the above applications are incorporated herein by reference.

### FIELD OF THE INVENTION

The present invention relates to an automotive extruded side curtain airbag ramp and process for manufacturing same.

### BACKGROUND OF THE INVENTION

Safety restraints, such as side curtain air bags, are well known in the automotive industry for occupant protection in the event of a collision. In the event of a side curtain air bag deploying, an air bag ramp guides the deploying air bag to the desired cab position in the vehicle toward the predetermined position designed for helping protect the vehicle occupant.

Conventional side air bag ramps for side air bags are made from a single material, and the product designs make the ramps difficult to manufacture. In addition, the ramps are typically a plastic olefin and the polymer is tough. This makes attaching the airbag ramps to any material difficult, e.g., sewing to a headliner is difficult owing to the toughness of the material. By way of example, it is difficult for the suppliers to original equipment manufacturers to sew the ramps to the material, e.g., headliner material, because the tough ramp material is difficult to sew. To overcome this problem, if the ramp material were made thinner for making it easier to sew, then the thinner material could rip or otherwise break, which is yet another significant issue.

Therefore, it is desirable to have an economical side curtain air bag ramp and process for manufacturing same that incorporates an easily manufactured design and that is easier for customers to install an air bag device, e.g., sewn, fastener, clipped, etc.

### SUMMARY OF THE INVENTION

The present invention is generally directed to an airbag ramp, in particular, to an extruded side curtain airbag ramp and method for manufacturing same. The airbag ramp, according to the present invention incorporates a plurality of extruded materials and provides an easier manufactured product and attachment.

According to one preferred embodiment of the present invention the airbag ramp incorporates at least two materials, preferably at least three materials, more preferably at least four materials. A first material is a predetermined material that is hard. A second material is a predetermined material that is tear resistant. A third material is a predetermined material that is a softer material than at least the first material. The second material is suitable to allow operable connection to an airbag, in particular, preferably to the material of the headliner. Preferably, the second material allows the airbag ramp to be sewn to the airbag. Alternatively, the airbag ramp incorporates at least one fastener (e.g., at least one retainer, clip, extruded fastener, channel, barb, etc.) to operably connect to the airbag without the need to sew, or alternatively, in addition to sewing.

The fabrication of the airbag ramp is preferably an in-line up/down process incorporating at least two extruders. In accordance with one preferred embodiment of the present invention, at least a first extruder and a second extruder are provided. At least one of the materials is extruded or a plurality co-extruded at the first extruder forming predetermined features/profiles. The extrusion then runs into at least one mid-line fabrication device (e.g., at least one die, bulb die, etc.) to cut away or otherwise remove any predetermined material that is not needed in the end product to thereby begin to form or profile the product. The part is then run into the second extruder for extruding at least one of the other materials. More extruders and mid-line fabrication devices are contemplated depending on the application without departure from the scope of the present invention. The process in accordance with the present invention is easier to install or otherwise attach to a part and adds more value to manufacturing and the end product than conventional fabrication of airbag ramps.

According to an aspect of the present invention, an extruded open position allows for even cooling, and a substantially even wall thickness of a portion, e.g., a base, allows for improved even cooling and reduced warping.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevation view of an airbag ramp, in accordance with the present invention;

FIG. 2 is a front elevation view of an airbag ramp, in accordance with the present invention;

FIG. 3 is a front elevation view of an airbag ramp with a stiffening feature;

FIG. 4 is a front elevation view of an airbag ramp illustrating features of the present invention operable for eliminating the stiffening feature, in accordance with the present invention;

FIG. 5 is a schematic of a system for manufacturing an airbag ramp;

FIG. 6 is a perspective view of an airbag ramp, in accordance with aspects of the present invention;

FIG. 7 is a front elevation view of the airbag ramp, in accordance with aspects of the present invention;

FIG. 8 is a front elevation view of the airbag ramp;

FIG. 9 is a front elevation view of the airbag ramp with an exemplary processing position illustrated in phantom, in accordance with aspects of the present invention; and

FIG. 10 is a prior art ramp.

### DETAILED DESCRIPTION OF THE PREFERRED EMBODIMENTS

The following description of the preferred embodiment(s) is merely exemplary in nature and is in no way intended to limit the invention, its application, or uses.

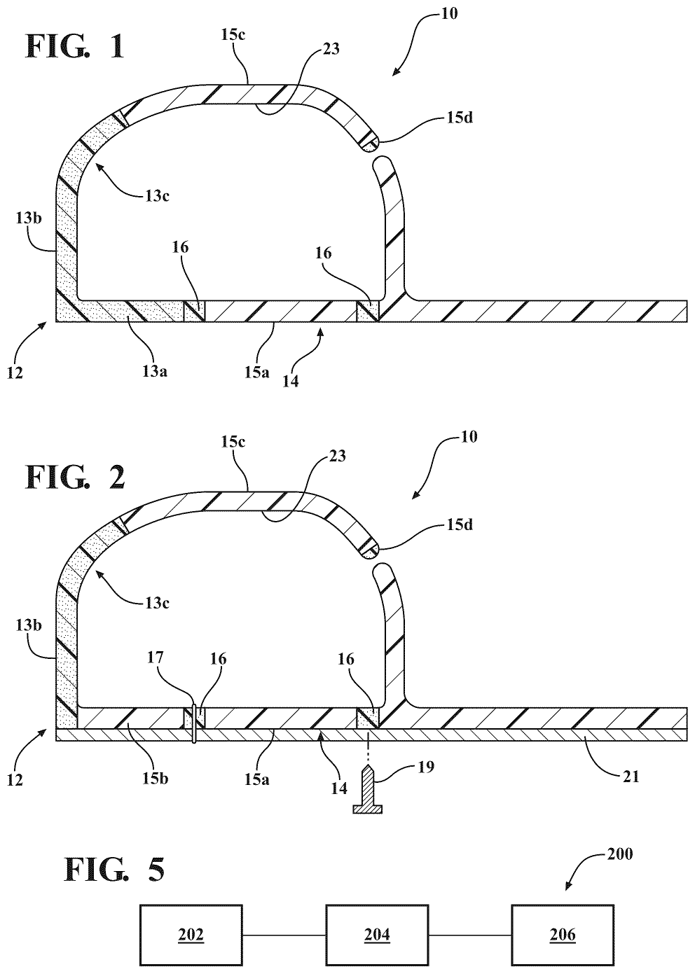

Referring to FIGS. 1-5 generally, and more particularly to FIGS. 1-2, in accordance with the present invention there is provided an extruded airbag ramp shown generally at 10. The airbag ramp 10 is preferably a side curtain airbag ramp. The airbag ramp 10 has many significant advantages, including that the airbag ramp 10 is operable for easier manufacturing and for connecting to an airbag easier, e.g., sewing or clipping to a part, e.g., sewing to a headliner. The airbag ramp 10 includes a plurality of predetermined materials, wherein at least one of the materials is a hard material and at least one of the materials is a material that is softer than the hard material. Preferably, at least one other of the materials is a tear-resistant material.

A first portion of the airbag ramp, shown generally at 12, is formed of a first material. The first material is preferably the hardest of all the other materials of the ramp 10. The first material is a polypropylene. Typically, the first material portion has a durometer of about 50D, however, greater, or lesser durometers are contemplated depending on the application without departure from the scope of the present invention. The first portion 12 has a predetermined shape and dimensions (e.g., profile(s), shape(s), contour(s), thickness(s), length(s), width(s), height(s), etc.) depending on the particular application. FIG. 1 depicts the first portion 12 with an exemplary generally horizontal section 13a and a generally vertical section 13b with a generally curved section indicated generally at 13c. Preferably, the sections 13a-13c are integrally formed in the same extruder, e.g., a first extruder, as will be described further below. FIG. 2 depicts the first portion 12 of the first material with an exemplary predetermined profile that does not include the generally horizontal section 13a of FIG. 1. It is understood that the exemplary sections in the Figures are adaptable to any application and can be any predetermined configuration depending on the particular application without departure from the scope of the present invention.

A second portion of the airbag ramp, shown generally at 14, is formed of a second material. The second material is softer than the first material. The second material is preferably a thermoplastic olefin (TPO). Typically, the second material portion has a durometer of about 50B, however, greater, or lesser durometers are contemplated depending on the application without departure from the scope of the present invention. The second portion 14 has a predetermined shape and dimensions (e.g., profile(s), shape(s), contour(s), thickness(s), length(s), width(s), height(s), etc.) depending on the application. FIG. 1 depicts the second portion 14 with an exemplary generally horizontal first section 15a. The second portion 14 further includes another portion 15c (FIGS. 1-2) or ramp section formed of the second material, e.g., extruded or co-extruded. The portion 15c adjoins the structural section 12 at one end. The first portion 15a adjoins the structural section 12, preferably, the generally horizontal first section 13a of the structural portion 12 at the other end. FIG. 2 depicts the second portion 14 with an exemplary generally horizontal first section 15a including a further extending generally horizontal second section 15b adjoining to the first portion 12/13b. The second portion 14 further includes a third portion 15c (FIGS. 1-2) or ramp section formed of the second material, e.g., extruded or co-extruded. The third portion 15c adjoins the structural section 12. A channel 23 is formed by the cooperating sections 12 and 14 to receive a predetermined suitable component. The channel 23 generally runs the length of the assembly 10. It is understood that the exemplary sections in the Figures are adaptable for suitability in any application and can be any predetermined configuration depending on the particular application without departure from the scope of the present invention. It is understood that the assembly 10 is any predetermined length depending on the application without departure from the scope of the present invention.

Alternatively, the ramp section 15c is at least partly formed of a third material, typically a soft material, preferably thermoplastic vulcanizates (TPV). FIGS. 1-2 illustrate at least the end 15d of the ramp section 15c being TPV, which may be a cut away or otherwise formed end 15d in a mid-line fabrication device, as will be described in greater detail below.

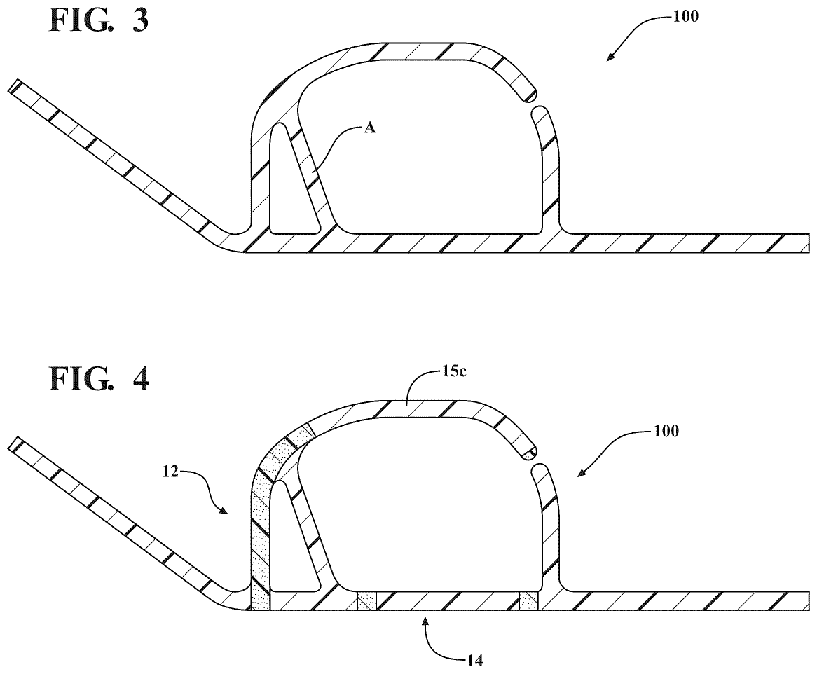

Referring to FIGS. 1-5 generally, and more particularly to FIG. 4 the use of the hard material eliminates the need for additional strengthening features, such as the expanse of material “A” indicated in FIGS. 3 and 4 located generally between the horizontal and ramp segments of an airbag ramp 100.

Referring to FIGS. 1-2 generally, the airbag ramp 10 includes at least one attachment portion 16 formed of a third material. The third material is preferably a predetermined tear-resistant material or anti-tear material. Preferably, there are at least two attachment portions 16 and 16 (see FIGS. 1-2). Most preferably, each attachment portion 16 is operable for sewing the airbag ramp 10 to at least one predetermined vehicle part 21, e.g., vehicular body panel, headliner, both the vehicular body panel and headliner, etc. An exemplary sew line is indicated at 17. Alternatively, or in combination with sewing, adhesive, or any other suitable attachment, at least one fastener 19 is incorporated with the airbag ramp 10 (e.g., at least one retainer, clip, extruded fastener, channel, barb, etc.) for attachment to the predetermined vehicle part. Other vehicle components for the airbag ramp to be attached to are contemplated depending on the application without departure from the scope of the present invention. Alternatively, the attachment portion 16 is formed as the same material as the structural portion 13b.

It is understood that the profile, shape, contour, and features and etc. of the airbag ramp 10 are adaptable for suitable use in any airbag for any vehicle, etc. depending on any and all applications without departure from the scope of the present invention.

It is understood that the materials and locations are exemplary. It is understood that the portions and part profiles are exemplary. The airbag ramp part is adaptable for suitability according to any application without departure from the scope of the present invention.

Referring to FIGS. 1-5 generally, and more particularly to FIG. 5, according to an aspect of the present invention, the fabrication of the airbag ramp is preferably an in-line up/down process incorporating at least two extruders shown generally at 200. In accordance with one preferred embodiment of the present invention, at least a first extruder 202 and at least one second extruder 206 are provided. At least one of the materials (e.g., first material 12, preferably first 12 and second materials 14 and third 16 materials), is extruded (or co-extruded) at the first extruder 202 forming predetermined features/profiles and runs into at least one mid-line fabrication device 204 (e.g., at least one die, bulb die, etc.) to cut away or otherwise remove any predetermined material that is not needed in the end product to thereby begin to form or profile the product. The part is then run into the second extruder 206 for extruding at least one of the other materials (e.g., 15d). The process in accordance with the present invention is easier and adds more value to the end product than conventional fabrication of airbag ramps.

While a side curtain airbag ramp is described, it is understood that the present invention is adaptable for any airbag (e.g., front driver, front passenger) without departure from the scope of the present invention and adaptable for any extrusion in in industry (e.g., UTV, ATV, recreational vehicle, offroad vehicles) without departure from the scope of the present invention. It is further understood that the present invention is adaptable depending on the application without departure from the scope of the present invention, e.g., requiring an extrusion attached to a second component, seals, etc.

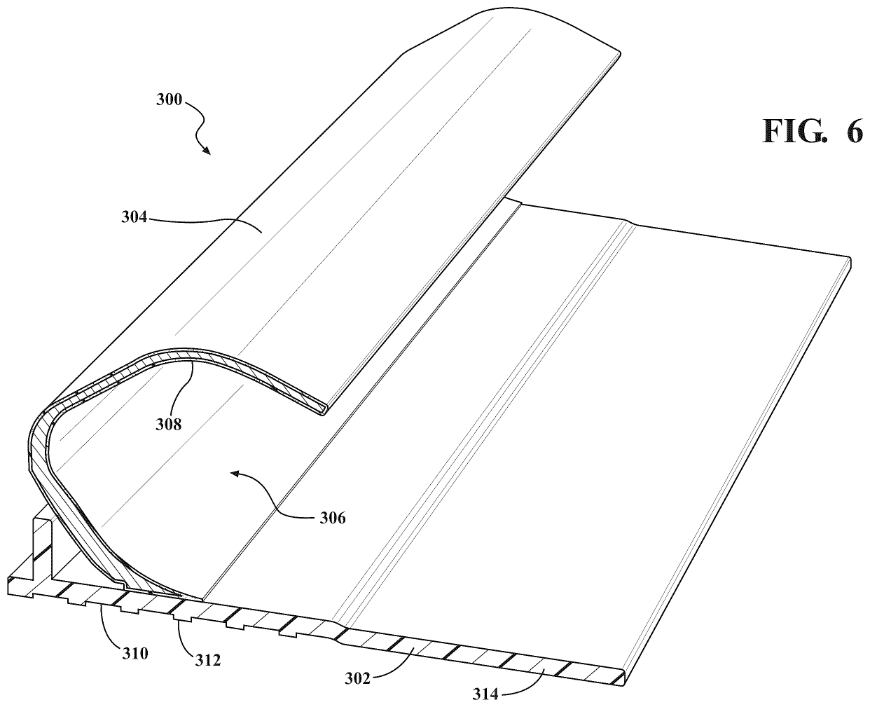

Referring to FIGS. 1-9 generally, and more particularly to FIGS. 6-9, there is provided an extruded airbag ramp shown generally at 300, in accordance with aspects of the present invention. The airbag ramp 300 is preferably a side curtain airbag ramp. The airbag ramp 300 has many significant advantages, including but not limited to, that the airbag ramp 300 is operable for easier manufacturing. The airbag ramp 300 includes a first portion 302, e.g., base, which includes an even wall thickness to reduce warp and bow, and a second portion 304, e.g., flap, of predetermined material and features operable to improve cooling, manufacturing line speed, and part quality. The second portion 304 includes a channel or opening, e.g., lateral opening, indicated generally at 306. The second portion 304 preferably generally forms a C-shape. The second portion 304 is generally at least a substantially solid curvilinear wall 308 of predetermined thickness, e.g., varied thickness along its length or substantially the same thickness. The second portion 304 is extruded in a first position, e.g., open position, to allow for even cooling. These were significant advantages over traditional features where this area is traditionally hollow resulting in uneven cooling, which reduces line speed and part quality.

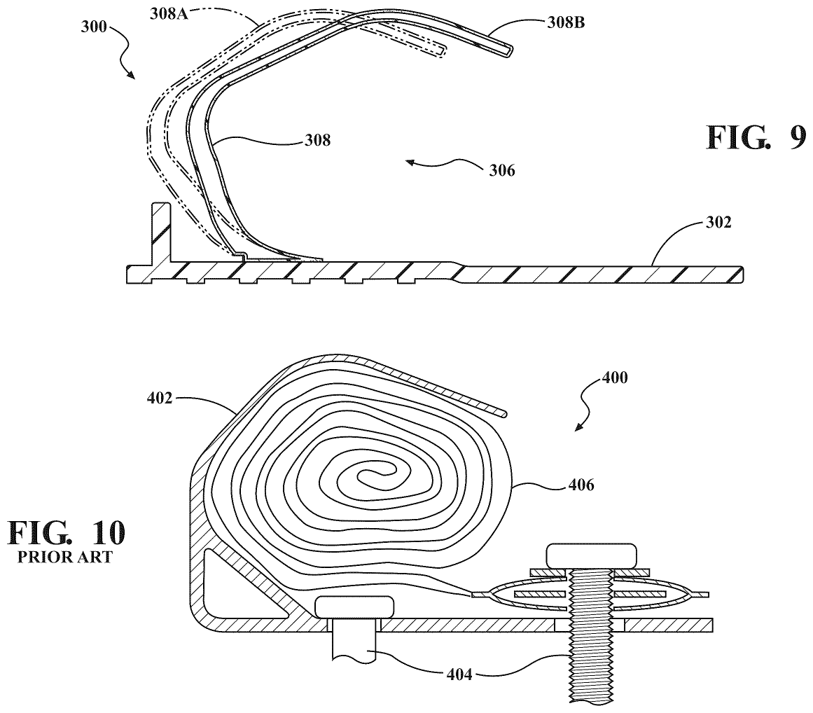

FIG. 9 depicts the second portion's 304 wall 308 in the exemplary first position, indicated at 308B overlaying the exemplary second position, indicated at 308A, depicted in phantom. Extruding the second portion 304, e.g., flap, in the first position 308B, e.g., open position, allows for even cooling. The second portion 304 cools to the exemplary second position 308B, while the first portion's 302, e.g., base, including the upstanding portion 18, having substantially even wall thickness reduces or eliminates warp or bowing of the airbag ramp 300 during cooling.

FIG. 10 depicts a prior art ramp assembly 400 including a ramp 402 with a disadvantageously hollowed-out base section, e.g., hollow corner along the assembly's length. The base includes apertures for bulky fasteners 404. A rolled deployable material 406 is positioned in the ramp 402.

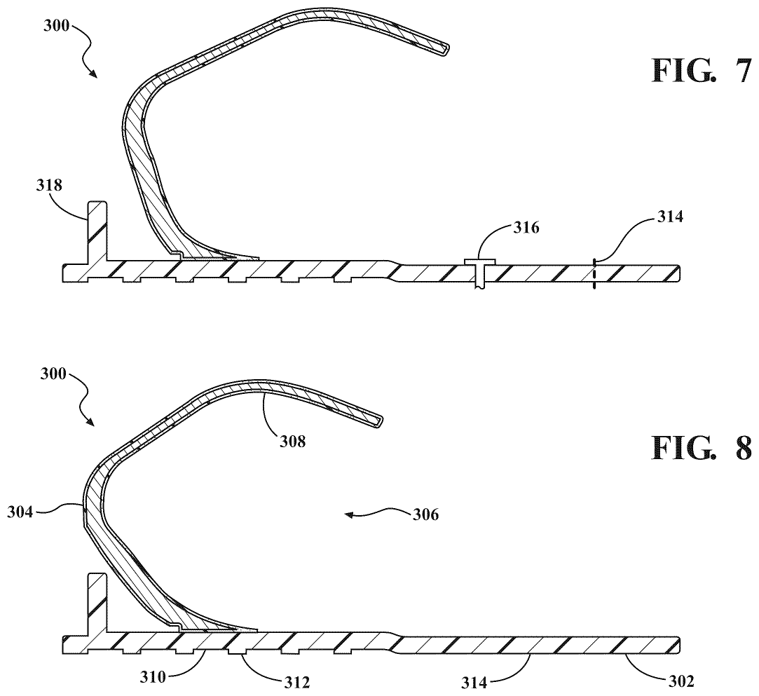

FIG. 7 depicts the exemplary first position, e.g., 308B of FIG. 9, rotated open for ease of processing. Material is also relieved, depicted at 310, in at least one location, preferably a plurality of predetermined locations, for ease of processing. The relief 310 of material is preferably a gap, recess, notch, or open channel, more preferably, such relief 310 located in the base 302, and more preferably, such relief 310 comprising a plurality of spaced apart reliefs 310, e.g., equally spaced reliefs separated by material of predetermined width, indicated at 312.

FIGS. 6 and 9 depict the exemplary second position, e.g., 308B of FIG. 9. The second position is an exemplary finished position after predetermined cooling of the extruded material.

The first portion 302, e.g., base, is preferably at least a polypropylene. The second portion 304, e.g., flap, ramp, is preferably at least a thermoplastic polyolefin. More preferably, the second portion 304 is a thermoplastic polyolefin and the first portion 302 is a polypropylene. Most preferably, the first portion 302, e.g., base, is polypropylene, and the second portion 304, e.g., flap, is thermoplastic olefin (TPO). It is understood that according to an aspect of the present invention, the airbag ramp 300 can additionally include at least one attachment portion formed of a predetermined third predetermined material, e.g., disposed in at least one location in the first portion 302, without departure from the scope of the present invention. In accordance with an alternative aspect of the present invention, the assembly 300 material is a single predetermined material.

The first portion 302 is operably adapted in at least one location to connect to operably the vehicle, e.g., for sewing 314 the airbag ramp 300 to at least one predetermined vehicle part 21, e.g., vehicular body panel, headliner, both the vehicular body panel and headliner, etc. Alternatively, or in combination with sewing 314, adhesive, or any other suitable attachment, or at least one fastener 316, etc., is incorporated with the airbag ramp 300 (e.g., at least one retainer, clip, extruded fastener, channel, barb, etc.) for attachment to the predetermined vehicle part. Other vehicle components for the airbag ramp to be attached to are contemplated depending on the application without departure from the scope of the present invention.

Referring to FIGS. 6-9 generally, in accordance with a preferred aspect of the present invention, the airbag ramp 300 includes a plurality of predetermined materials, wherein at least one of the materials is a hard material and at least one of the materials is a material that is softer than the hard material. The first portion 302 of the airbag ramp 302 is formed of at least one first material. The first material is preferably the hardest of all the other materials of the ramp 300. Typically, the first material portion has a durometer of about 50D, however, greater, or lesser durometers are contemplated depending on the application without departure from the scope of the present invention. The first portion 302 has a predetermined shape and dimensions (e.g., profile(s), shape(s), contour(s), thickness(s), length(s), width(s), height(s), etc.) depending on the particular application. The first portion 302 is preferably substantially L-shaped with a solid corner where the upstanding portion 318 and a substantially horizontal portion of the first portion 302 meet. The second portion 304 of the airbag ramp is formed of a second material that is preferably softer than the first material. Typically, the second material portion has a durometer of about 50B, however, greater, or lesser durometers are contemplated depending on the application without departure from the scope of the present invention. The second portion 304 has a predetermined shape and dimensions (e.g., profile(s), shape(s), contour(s), thickness(s), length(s), width(s), height(s), etc.) depending on the application. The channel 306 generally runs the length of the second portion 304.

It is understood that the profile, shape, contour, and features and etc. of the airbag ramp 300 are adaptable for suitable use in any airbag for any vehicle, etc. depending on any and all applications without departure from the scope of the present invention.

As explained in further detail above and FIG. 5, and incorporated herein, according to an aspect of the present invention, the fabrication of the airbag ramp 300 is preferably an in-line up/down process incorporating at least two extruders shown generally at 200.

It is understood that the materials and locations are exemplary. It is understood that the portions and part profiles are exemplary. The airbag ramp part is adaptable for suitability according to any application without departure from the scope of the present invention.

Referring to FIGS. 1-3 and 5-9 generally, while a side curtain airbag ramp is described, it is understood that the present invention is adaptable for any airbag (e.g., front driver, front passenger) without departure from the scope of the present invention and adaptable for any extrusion in in industry (e.g., UTV, ATV, recreational vehicle, offroad vehicles) without departure from the scope of the present invention. It is further understood that the present invention is adaptable depending on the application without departure from the scope of the present invention, e.g., requiring an extrusion attached to a second component, seals, etc.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. An extruded airbag ramp, comprising:
a plurality of materials wherein at least one first material is operable to provide a first portion that is a structural portion of the extruded airbag ramp including a plurality of material recesses along the structural portion length to operable to provide ease of processing, said structural portion including an attachment portion operably adapted to attach said airbag ramp to a predetermined part, and wherein at least one second material is operable to extrude a spans of material of a second portion in a rotated open position operable for ease of processing and to allow even cooling into a final position.

2. The extruded airbag ramp of claim 1, wherein the first portion is sewn to the predetermined part.

3. The extruded airbag ramp of claim 1, wherein the predetermined part is a headliner for a vehicle.

4. The extruded airbag ramp of claim 1, wherein the attachment portion includes at least one fastener attachable to said predetermined part.

5. The extruded airbag ramp of claim 4, wherein the at least one fastener is at least one clip.

6. The extruded airbag ramp of claim 1, where the first portion includes a substantially even wall thickness operable to prevent the extruded airbag ramp from warping and bowing.

7. The extruded airbag ramp of claim 1, wherein said the extruded airbag ramp is a side curtain airbag ramp and is operably connected to said predetermined part, wherein said predetermined part is a headliner for a vehicle.

8. The extruded airbag ramp of claim 1, wherein the first portion is substantially L-shaped and without a hollow corner.

9. The extruded airbag ramp of claim 1, wherein the structural portion of said airbag ramp has a higher durometer than said second portion.

10. The extruded airbag ramp of claim 1, wherein the structural portion provides predetermined amount of stiffness to eliminate an expanse of material required for strengthening substantially between the structural portion and attachment portion.

11. The extruded airbag ramp of claim 1, wherein the first portion is a substantially C-shaped flap.

12. The extruded airbag ramp of claim 1, a durometer of at least one material is at least about 50D.

13. The extruded airbag ramp of claim 1, wherein the first material is polypropylene.

14. The extruded airbag ramp of claim 1, wherein the second material is thermoplastic olefin.

15. An extruded airbag ramp for a vehicle, comprising:
at least one predetermined extrudable material operable to provide a first portion and a second portion, said first portion including a substantially even thickness along the first portion length operable to prevent warping, and a plurality of reliefs operable to ease processing, said second portion including a laterally open channel portion extrudable in a first position and operably rotated to a second position as the material cools substantially evenly to a final position.

16. A method of manufacturing an extruded airbag ramp, comprising:
providing at least one first material;
providing at least one second material;
extruding a first portion incorporating a substantially even wall thickness operable to reduce warping and bowing, said first portion including a plurality of recesses substantially evenly spaced apart operably adapted for said first portion to operably cool to the desired final positional;
co-extruding a second portion of said first or second material in a first rotated open position, wherein said second portion operably automatically rotates to a final second position as the second portion substantially cools evenly.

17. The method of claim 16, further comprising sewing said first portion to a predetermined automotive part.

18. The method of claim 16, wherein the first portion and/or second portion includes a corner area adjacent where the first and second portions contact that is not hollow, wherein said non-hollow portion in combination with said second portion extruded in said first rotated open position is operable to allow even cooling after said extruding to automatically form said final second position.

19. The method of claim 16, wherein the first portion is an L-shaped structural portion formed of polypropylene.

20. The extruded airbag ramp of claim 16, wherein the second portion is a C-shaped flap formed of thermoplastic olefin.
